(19) United States
(12) Patent Application Publication
(10) Pub. No.: US 2006/0005345 A1
(43) Pub. Date: Jan. 12, 2006

(54) Hand held steam cleaner

(76) Inventor: Raymond Hoi-Tak Lam, Wanchai (HK)

Correspondence Address: GALLAGHER & KENNEDY, P. A., 2575 E. CAMELBACK RD. #1100, PHOENIX, AZ, 85016, US

(21) Appl. No.: 10/887,779

(22) Filed: Jul. 9, 2004

(51) Int. Cl. A61H 33/12; F17C 7/04

(52) U.S. Cl. 15/320; 392/404

(57) ABSTRACT

A hand held steam cleaner of relatively small pistol shape has a rearward projecting water container from which water is pumped by a pump within the main housing of the cleaner to a tank having a heater embedded in one wall thereof for the conversion of the water to steam. A one-way valve permits the entry of air into the container as water is pumped from it. A steam relief valve connected into a water line running from the pump to the tank opens when steam pressure becomes excessive, as when the steam cleaner nozzle is blocked. The tank in which water is converted into steam has two serpentine paths generally paralleling two sides of a U-shaped electrical heater in heat conducting relation to the paths. The path's topography is such that the surface area of the wall of the tank shared with the heater is greatly increased by a multiplicity of projections. A nose member of the cleaner receives the stem of various cleaning tools, locking them in place in fluid communication with the nozzle.

### FIELD OF THE INVENTION

This invention relates to a hand held steam cleaner and more particularly to a hand held steam cleaner that has a water container and a pump for delivering water from the container to a tank that is electrically heated to produce steam which is thereafter emitted through a nozzle to an area to be cleaned.

### BACKGROUND

Steam cleaners have been know that have drawn water from a container, converted it to steam and emitted the steam at a nozzle that was equipped to carry one of various cleaning tools such as brushes, wipers, etc. These were often two component arrangements wherein the water container was adapted to rest on the floor where the water is heated and converted to steam that is then delivered through a flexible tube to a cleaning head. The steam then has been delivered through a nozzle on the cleaning head. These devices have been unwieldy and the delivery of steam through a long length of hose raises the possibility of significant condensation of the steam back to water. A similar device equips the water container and steam production unit with a handle so as to be carried by the user from place to place while again a cleaning head is manipulated to emit steam delivered via flexible hose. The device is awkward. Needless to say, if both hands are needed for the cleaning task, a hand is not available to move the water container and steam producing unit. For this reason a strap has been proposed on one such device, but this requires the cumbersome water container and steam producing unit to be strapped to the user's body. Neither the use of the handle, nor the strapping of the unit to the body addresses the question of increased likelihood of condensation by delivery of steam through the hose attaching the two units.

Self contained and hand manipulated steam cleaners have been sold, but they have often been large, bulky and difficult to manipulate. If smaller, some cleaners have contained insufficient water to allow steam cleaning for a reasonable amount of time or have delivered an insufficient flow of steam for proper cleaning. Some have employed a hand operated pump to deliver water to a boiler where steam is created. There is a need, then, for a relatively compact, well-balanced, readily manipulated, single unit hand held steam cleaner that delivers steam at a rate sufficient for most cleaning tasks and over a reasonably long period so that the cleaning need not be often interrupted to replenish water in the cleaner.

### BRIEF SUMMARY

In accordance with this invention a hand held steam cleaner is of a relatively small size, has an easily manipulated pistol shape. When a trigger is depressed to activate a switch the steam cleaner delivers a sustained, relatively high flow of steam over a sufficiently long period to permit few or no interruptions for refilling.

In one preferred embodiment the hand held steam cleaner has an electric water pump with a capacity of at least approximately 55 ml per minute and a heated tank that, despite its small size, is able to convert water to steam at that rate and deliver it to the steam cleaner's nozzle. In a more preferred, exemplary embodiment, the rate of delivery of water to the tank is approximately 70 ml per minute. The tank preferably has an electrical heater coupled in heat conducting relation to a wall thereof. In a preferred embodiment, the interior surface of that tank wall has a surface area increasing topography with numerous surface area increasing projections or undulations such that a large, hot surface area is brought into contact with the water being converted to steam. In that embodiment, baffles formed along the flow of water in the tank define a serpentine path or paths from the tank inlet to the nozzle. This lengthens the path along which heat transfer to the water occurs. In a preferred, exemplary embodiment the tank has the electrical heater imbedded in the wall by casting the tank about the heater. This assures excellent heat transfer from the heater to the tank wall. The tank is preferably cast of a good heat conductor like aluminum.

The heater may be a resistive heater and U-shaped. Preferably, two of the serpentine paths extend along the length of the two legs of the U-shaped heater generally parallel to the legs and close to the legs.

A water container is detachably connected to a housing that includes a forward barrel and a hand grip. A one way valve, in one preferred embodiment, is formed through a wall of the water container. Two small holes open into the container closely proximate one another. Into one hole is inserted a tack-shaped soft and pliant insert, the head of which is on the interior side and a portion of which overlies the second hole. The head prevents water escaping, but when water is pumped from the container the flexible head of the insert bends away from its underlying hole to permit air entering the container. This makes it possible to continue to pump water. A water line leading from the container to a small electrical pump in the housing includes, within the container, a flexible plastic tube leading to the water outlet of the container. The tube has affixed to a free end a relatively heavy intake element that will bend the tube and locate the inlet element below the level of the water in the container irrespective of the angle or attitude at which the cleaner is held.

For safety, the preferred, exemplary embodiment of the invention has a steam release valve that vents hot steam and/or water under pressure to atmosphere in the event of steam pressure buildup. Communicating with a water flow path from the pump to the heated tank is a tube that terminates in a steam release cap extending through a wall of the steam cleaner housing. Tightly held within the tube adjacent to the cap is a metal, preferably stainless steel, ball that is in fluid-type engagement with the interior of the tube. Should it occur that steam pressure builds within the tank and the water delivery path from the pump to the tank as may occur when the unit's nozzle is blocked, hot steam and/or water under pressure will reach the tube at the location of the ball. The tube is of a thermoplastic and expands under the increased heat and increased pressure to permit steam and/or water to move around the ball and into the cap, escaping to atmosphere thus relieving the pressure buildup. The cap's inner tip is slotted across so that the ball, if it engages the tip, does not block the passage through the cap.

The steam cleaner is conveniently controlled by a trigger-like switch actuator located on the hand grip. It switches electrical power to the pump to cause delivery of water to the heated tank. The temperature of the tank is thermostat controlled. A thermostat is secured in heat conducting relation to the tank wall carrying the heater. The thermostat is operative to break the electrical connection to the heater at a desired temperature. Preferably, breaking this connection also changes the state of an indicator lamp (i.e. from on to off or vice versa), whereby the user is made to know that the tank has reached its optimum temperature and steam cleaning can proceed.

In a preferred embodiment, absent the attachment of any cleaning tool at the nozzle, the steam cleaner has only a length of less than approximately 13 inches, a height of less than approximately 8 inches and a width less than approximately 3½ inches. Consequently the steam cleaner is easily manipulated manually.

The above and further objects and advantages of the invention will be better understood with reference to the following detailed description taken in consideration with the accompanying drawings.

### BRIEF DESCRIPTION OF THE DRAWINGS

FIG. 1 is a perspective view of a hand held steam cleaner in accordance with the present invention;

FIG. 2 is a top plan view of the steam cleaner of FIG. 1;

FIG. 3 is an enlarged cross-sectional view of the steam cleaner of FIGS. 1 and 2 taken along the line 3-3 in FIG. 2 with certain interior parts illustrated in elevation;

FIG. 4 is an enlarged side elevation view with parts broken away for clarity of a tank and heater for converting water to steam in the steam cleaner of FIGS. 1 and 2;

FIG. 5 is a top plan view of the tank of FIG. 4 with a cover plate removed to reveal the tanks' interior;

FIG. 6 is a schematic illustration of the electrical interconnections of the FIG. 1 steam cleaner;

FIGS. 7(a) and (b) are perspective views of interfitting nose members and;

FIG. 8 is an enlarged fragmentary cross-sectional view of a one-way valve admitting air into the interior of a water container permitting pumping of water from the container; and

FIGS. 9(a) and (b) are perspective views of interconnecting elements of a water container and body of the steam cleaner of FIGS. 1 and 2.

### DETAILED DESCRIPTION

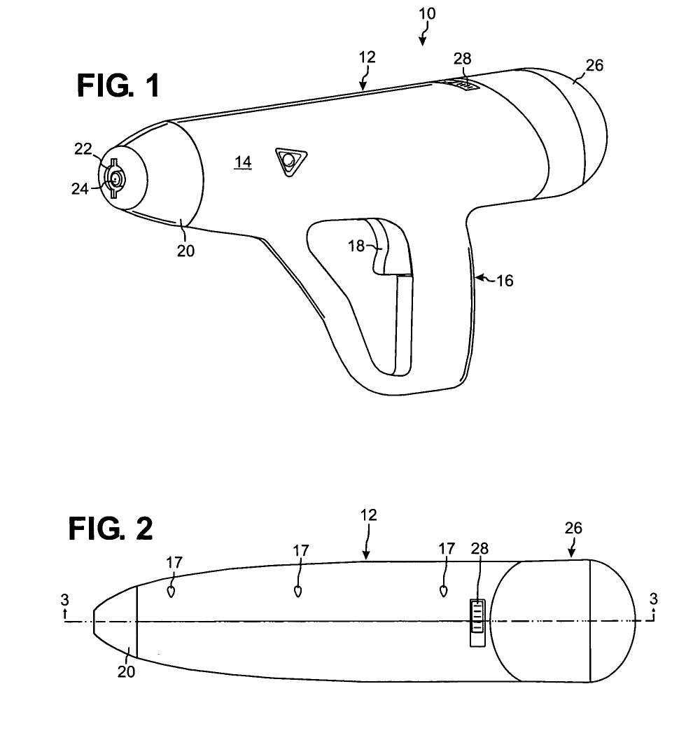

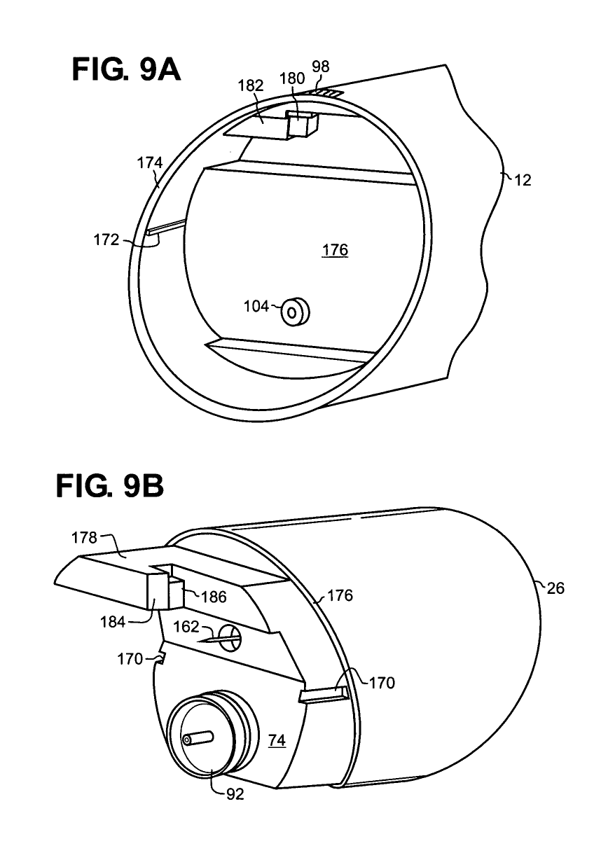

Turning now to FIG. 1, there is shown a hand held steam cleaner 10 in accordance with the present invention. The cleaner is generally pistol shaped and includes a housing 12 that has a barrel section 14 and a hand grip 16. The housing may, for example, be molded in two halves and held together by screws introduced through holes in one of the halves at suitably chosen locations such as, e.g. the holes 17. A trigger-like switch actuator 18 is carried by the hand grip. A generally conical nose member 20 is detachably connected to the main housing 12. The nose member 20 has a central opening 22 in which is located a, preferably brass, nozzle 24. One of a number of cleaning tools such as brushes, wipers and the like may attach to the nose member in fluid communication with the nozzle 24 as described below. Rearward of the hand grip 16, a water container 26 detachably connects to the main housing 12. A slide 28, best seen in FIG. 2 and again in FIG. 9(a), is finger operated to release the container 26 from the housing 12.

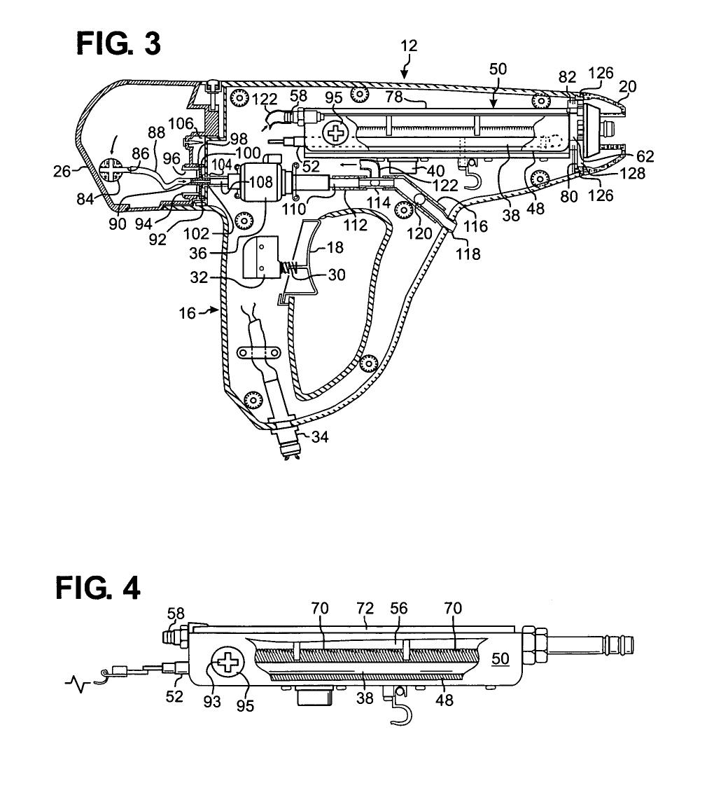

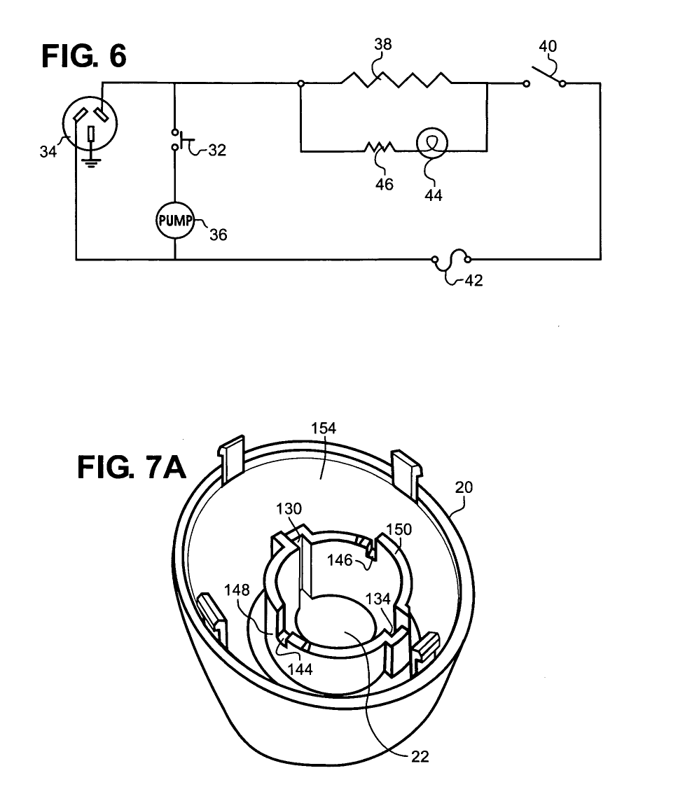

As shown in FIG. 3, the trigger 18 is biased outward from the hand grip 16 by a spring 30. When depressed, the trigger 18 closes a switch 32 also shown in the schematic of FIG. 6. This closes a circuit from an electrical plug 34 to a pump 36 again as schematically illustrated in FIG. 6. The pump 36 in one preferred exemplary embodiment is a commercially available electric pump operating on 120V A.C. at 60 HZ and rated at 70 ml./min. ±20%. A heater 38 is connected to the plug 34 via a thermostat 40 and fuse 42 (in FIG. 6). An indicator lamp 44 (in FIG. 6) in series with a current limiting resistor 46 is connected across the heater 38.

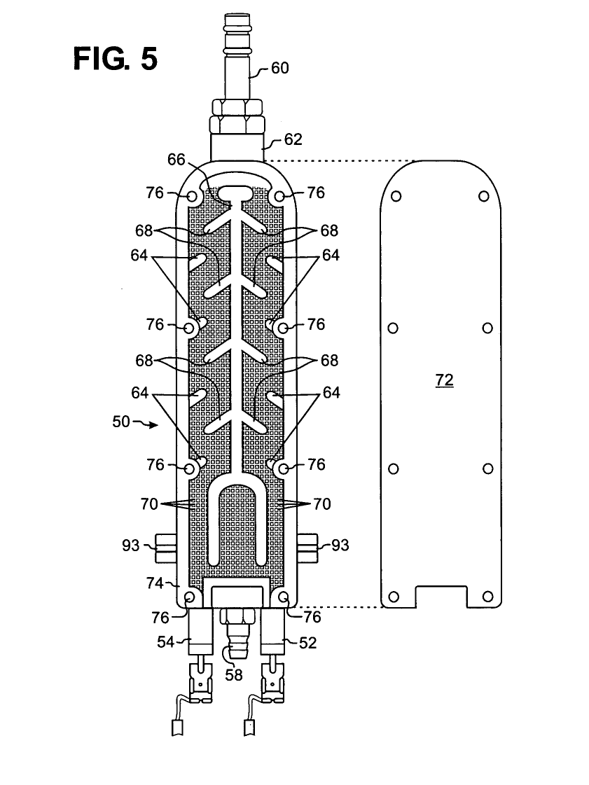

As best seen in FIG. 4, the heater 38 is imbedded in a wall 48 of a tank 50. The tank 50 may be of cast aluminum, molded about the heater 38 for excellent heat transfer from heater to tank wall. The heater 38 may be a resistive “Calrod” type heating element. It is of an extended U shape, running substantially the entire length of the tank 50. Its two ends and electrical connections thereto can be seen at 52 and 54 in FIG. 5. An interior recess 56 within the tank 50 and as shown in FIGS. 4 and 5 receives water at one end thereof and emits steam from the other. When activated, the pump 36 pumps water through a water inlet tip. The water proceeds along a pair of serpentine paths indicated by the unnumbered arrows in FIG. 5. Steam emerges under pressure from a nozzle 60 that threads into a boss 62 integrally formed on the tank 50. The serpentine paths are defined by a series of side baffles 64 integrally cast into the interior of the tank 50 and a central divider 66 defining further baffles 68. The serpentine paths provide a longer path to improve heat transfer to water moving along them. Along the entire water to steam conversion paths within the tank 50, integrally cast, pyramid-shaped projections 70 cover the surface of the bottom wall, increasing the surface area for still better heat transfer to the water introduced into the tank. A plate 72 shown in FIG. 4 closes the tank. A series of screws (not shown) screw the plate 72 into tight engagement with a gasket 74 seated within the tank 50 as shown in FIG. 5. Screw holes 76 are provided in bosses within the tank to receive the screws holding the plate 72 in place. A thermal blanket 78 in FIG. 3 is wrapped about the tank 50 and may be secured by a fiber tie wound around and tying the blanket in place (not shown) or by other convenient means.

Tank 50 is supported in the housing by a suitably sized flange 80 molded as part of the housing and engaging a silicon rubber washer 82 received on the boss 62 at the front of the tank. A pair of cruciform projections 93 are integrally cast on the tank 50 opposite sides thereof. These receive a further pair of silicon rubber washers 95 (one of which is shown in FIG. 3 and FIG. 5). The holders 95 fit into a pair of sockets (not shown) integrally molded with the sides of the housing 12 to support the tank 50 at its back end.

When the pump 36 is activated, water flow out of the container 26 through the pump and to the tank 50 begins at a spherical water intake element 84. The element 84 has a tubular extension 86 that enters a long, flexible plastic tube 88 of, for example, silicon rubber. The tube 88 connects to an inwardly directed projection 90 of a water container cap 92. The cap has a cylindrical skirt 94 that fits into a water container opening 96. The skirt 94 carries a washer like seal of, again, silicon rubber or other soft plastic material capable of sealing engagement between the edge of the container opening 96 and a head 100 of the cap 92. An outward projecting hollow tubular part 102 of the cap 92 is in fluid communication with the inward directed projection 90. The hollow member 102 extends into a rubber seal 104 when the container 26 is mounted to the steam cleaner housing 12. The seal 104 extends through a rear wall 106 of housing 12. At its forward end the seal, which is hollow, connects onto a cylindrical inlet 108 of the pump 36. The intake element 84, tube 88, cap 92 and seal 104 thus form a first water flow line from the container to the pump. The spherical intake element 84 in the container 26 is of a material, brass for example, that is heavy enough to bend the tube as gravity keeps the element 84 at or near the bottom of the pool of water in the container regardless of the attitude of the steam cleaner. The element 84 may have a number of openings from the surface to the extension 86 as illustrated.

The pump 36 has a cylindrical outlet 110. Onto it fits a flexible plastic sleeve 112. The sleeve 112 extends onto a 3-way tube 114. The 3-way tube opens into the sleeve 112 in one direction and into a further sleeve 116 in the opposite direction. The sleeve 116 fits onto a steam release cap 118 that opens through a wall of the housing 12. Tightly received in the sleeve 116 adjacent the internal end of the relief cap 118 is a stainless steel ball 120. A further branch of the 3-way tube 114 receives a flexible plastic tube 122. That tube extends to the water inlet tip 58 of the tank 50. The sleeve 112, 3-way tube 114 and tube 122 form a second water flow line from the pump to the tank.

In the event that steam pressure rises beyond an acceptable level in the tank 50, as may occur if the nozzle 60 is blocked, steam backs up through the tube 122, the 3-way tube 114 and the sleeve 116. There, pressure and heat effects enlargement of the thermoplastic sleeve 116 such that hot steam and/or water under pressure is able to flow past the ball 120. The inward tip of the steam relief cap 118 is slotted across at 124 so that the ball 120 does not block entrance of the steam into the cap. In this way overpressure within the steam cleaner is relieved.

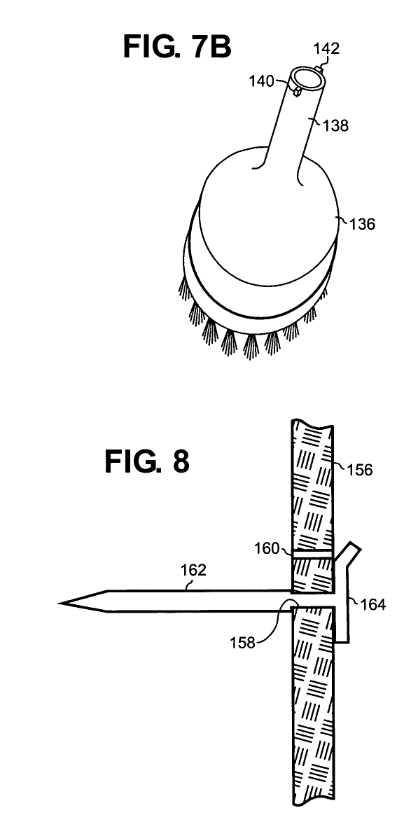

The nose member 20 of the steam cleaner (FIGS. 3 and 7(a)) has integrally molded and slightly flexible connectors 126 whose outwardly turned ends snap into place through holes formed in a front wall 128 of the housing 12. As shown in FIGS. 7(a) and 7(b) the nose element 20 has a hollow interior. A generally circular opening 22 has radially opposite slots 130 and 131, the slot 134 being slightly wider than the slot 130. This difference in widths assures proper insertion into the opening of one of several cleaning tools such as the brush 136 of FIG. 7(b). These tools have a stem 138 and a pair of radially opposite projections 140 and 142, the projection 142 being slightly wider than the projection 140 such that it will fit only in the slot 134 and not in the slot 130. Inside the tip 20 integrally molded raised surfaces permit the tool or brush 136 to be turned to its proper orientation with the projection 142 seated on a first land 144 and the projection 140 seated on a somewhat narrower second land 146. A pair of heightened wall segments 148 and 150 prevents turning the tool or brush 136 towards the wrong orientation. Ends of the heightened wall segments 148 and 150 define edges of the lands 144 and 146, respectively, along with a pair of slightly raised bosses 152 and 154.

Shown in FIG. 8 is the one way air inlet valve arrangement of the container 26. A slightly recessed circular section 156 of the forward wall of the container has formed therein a pair of closely spaced openings 158 and 168. A tack-shaped insert 162 of pliant plastic or rubber extends through the hole 158 where it is tightly retained. The head 164 overlies the opening 160. When water is pumped from within the container 26, air pressure against the head 164 of the tack-shaped insert 162 causes the head to bend away from the opening 160 as illustrated in FIG. 8. This permits the introduction of air allowing liquid to be pumped from the container 26.

The means for connecting the container 26 with the housing 12 is shown in FIG. 9. The container 26 has a pair of slots 170 that interfit with a pair of guiding ribs 172 formed on the interior of the sides of the housing 12. These lead the end face 174 of the container to face the opposing end face 176 of the housing 12. This brings the cap 92 to the seal 104. The rim 174 of the housing 12 aligns with a shoulder 176 on the container 26. At the same time a protruding catch member 178 on the container 26 moves into a recess 180 in the housing 12. A slidable latch 180 connected to the slide 28 is spring biased to its position projecting from a box 182 formed in the housing 12. The box 182 contains a small coil spring urging the latch outward. The surface of the latch engages a beveled surface 184 on the catch and is cammed back into the box 182 as the latch moves to alignment with a shallow slot 186 into which it snaps, retaining the container 26 in place on the housing 12.

Although preferred embodiments of the invention have been described in detail, it will be readily appreciated by those skilled in the art that further modifications, alterations and additions to the invention embodiments disclosed may be made without departure from the spirit and scope of the invention as set forth in the appended claims.

I claim:

1. In a steam cleaner of the type comprising a refillable water container, a tank, a heater coupled to the tank, a pump, water flow lines leading from the water container to the pump and from the pump to the tank, a switch for electrically activating the pump and a nozzle for directing steam formed in the tank to a location to be steam cleaned; the improvement comprising a generally pistol-shaped housing having a hand grip, a trigger carried by the hand grip and operably connected to the switch, a barrel section extending forward of the hand grip, the barrel containing the pump, the water flow line leading from the pump to the tank, the tank and the heater and carrying the nozzle at a forward end, the container and the housing having detachably interconnecting parts for securing the container to a rearward end of the housing, the container extending rearward beyond the hand grip, a nose member affixed to the housing forward end surrounding the nozzle, the nose member having an opening to the nozzle, the opening being adapted to receive a cleaning tool stem and having interfitting locking features for securing the tool stem in place with an opening in the stem in fluid communication with the nozzle.

2. The steam cleaner according to claim 1, wherein the water flow line leading from the container to the pump includes a flexible tube in the container extending to a fluid outlet of the container in fluid communication with the pump and having an intake element affixed at an intake end of the flexible tube, the intake element being sufficiently heavy to flex the tube so as to reside below the surface of water in the container irrespective of the attitude of the steam cleaner.

3. The steam cleaner according to either claim 1 or claim 2, wherein the container has a one way valve communicating between the interior and the exterior of the container and opening into the container to permit air flow into the container as water is pumped out of the container.

4. The steam cleaner according to claim 3, wherein the one way valve comprises two adjacent openings through a wall of the water container, a valve member of pliable plastic or rubber secured in one of the openings, the valve member having an enlarged head overlying the other of the openings and sealing the other of the openings from the passage of water out of the container, the enlarged head being responsive to a reduction of pressure in the container as water is pumped out of the container and flexing to admit air to the container.

5. The steam cleaner according to claim 1, further comprising a thermostat mounted in heat transfer relation to the heater and connected to open an electrical current path to the heater upon the heater and tank reaching a temperature sufficiently high to effect the production of steam in the tank when water is pumped into the tank.

6. The steam cleaner according to claim 1, wherein the tank has at least one interior surface in heat transfer relation to the heater and defining surface area increasing projections for increased heat transfer to water entering the tank.

7. The steam cleaner according to either claim 1 or claim 6, wherein the heater is imbedded in a wall of the tank.

8. The steam cleaner according to claim 7, wherein the tank is of a heat conductive material cast about the heater to provide intimate, heat transferring contact between the heater and the walls of the tank in which it is imbedded.

9. The steam cleaner according to claim 7, wherein a thermostat is secured in heat conducting relation to the wall of the tank and in electrical current controlling relation to the heater.

10. The steam cleaner according to claim 5, further comprising a lamp, the thermostat being further connected in current controlling relation to the lamp, whereby the lamp state indicates whether the tank has arrived at its steam producing temperature.

11. A compact, generally pistol-shaped steam cleaner having a housing containing a tank and a tank heater for conversion of water to steam, a steam nozzle affixed to the tank and projecting from within the housing, a hand grip rearward of the nozzle with a switch activator thereon, an electrical current path through a switch activated by the switch activator to a pump within the housing, a water container detachably connected to the housing, absent the connection of a cleaning tool, the tank, pump and container being interconnected to pump water from the container to the tank, means for connecting a cleaning tool in fluid communication with the nozzle, the steam cleaner having a length of less than approximately 13 inches, a height of less than approximately 8 inches and a width less than approximately 3½ inches.

12. The compact, generally pistol-shaped steam cleaner according to claim 11, wherein the pump has pumping capacity in excess of approximately 55 ml/min.

13. A hand held steam cleaner comprising a housing, a water container detachably connected to the housing, a first water flow path communicating between the housing and a pump, a second water flow path connected between the pump and a water heating tank, a nozzle in communication with the tank, an electrical heater connected in heat conducting relation to the tank, electrical conductors connected to the electrical heater, a manually operable switch controlling electrical conduction through the conductors and the heater, a pressure release valve connected between the second flow path and atmosphere, the pressure release valve including a thermoplastic tube in fluid communication between the second flow path and a steam relief cap extending through a wall of the housing, a ball secured within the tube proximate an inner end of the steam relief cap, the ball being tightly fit within the tube at normal pressure and temperature during operation of the steam cleaner, and the tube expanding to permit steam or water passage past the ball when hot steam or water under pressure backs up from the tank to the location of the ball.

14. The hand held steam cleaner according to claim 13, wherein the steam relief cap has an inner tip received in the thermoplastic tube, the inner tip being slotted to permit passage of hot steam or water through the cap in the presence of the ball at and in engagement with the tip.

15. The hand held steam cleaner according to claim 14, further comprising a three-way tube connected with the thermoplastic tube and connected into the second water flow path.

16. A hand held steam cleaner comprising a housing, a water container detachably connected to the housing, a hand grip, a heater in heat conducting relation to a tank, a water path from the interior of the water container to the tank, the water path including an electric water pump having a capacity of at least approximately 55 ml/min., and a nozzle in communication with the tank, the tank having a heat conducting wall for conducting heat from the heater to the interior of the tank for conversion of water to steam, the heat conducting wall having a water-contacting surface with a surface area increasing topography across the interior of the tank, whereby the heater and tank are capable of converting to steam the at least approximately 55 ml/min. of water delivered by the pump.

17. The hand held steam cleaner according to claim 16, wherein the pump has a capacity of approximately 70 ml/min. and the heater and tank convert water to steam at the approximate 70 ml/min. delivered by the pump.

18. The hand held steam cleaner according to claim 17, wherein the interior of the tank has defined therein at least one serpentine path from a water inlet to a steam nozzle.

19. The hand held steam cleaner according to claim 18, wherein the surface area increasing topography includes a multiplicity of projections formed on the wall.

20. The hand held steam cleaner according to claim 18, wherein the wall is cast about the heater to afford intimate heat transferring contact between the heater and the wall.

21. The hand held steam cleaner according to claim 20, wherein proximate the water inlet the interior of the tank branches into a pair of serpentine paths to the steam nozzle.

22. The hand held steam cleaner according to claim 21, wherein the heater is U-shaped, the serpentine paths generally paralleling legs of the U-shaped heater in close proximity thereto.

23. The hand held steam cleaner according to claim 18, wherein the at least one serpentine path is defined by a series of baffles projecting at opposite sides of the at least one serpentine path, the baffles at one side of the at least one serpentine path being offset from the baffles at the other side of the at least one path, the baffles being integrally cast with the wall.
